(19) United States
(12) Patent Application Publication
(10) Pub. No.: US 2013/0098307 A1
(43) Pub. Date: Apr. 25, 2013

(54) CATTLE FOOT BATH

(71) Applicant: Scott Offhaus, Batavia, NY (US)

(72) Inventor: Scott Offhaus, Batavia, NY (US)

(21) Appl. No.: 13/279,320

(22) Filed: Oct. 23, 2011

(51) Int. Cl. A01K 13/00; A01K 29/00

(52) U.S. Cl. 119/664; 119/667; 119/669

(57) ABSTRACT

The present invention is a cattle footbath utilized to clean debris off of a cow's hoofs that includes a base path surface, a pair of side walls that are adjustably disposed on the base path surface and form a pathway to accommodate a cow to walk through, a pair of brushes that are disposed adjacently inward from the side walls where the bristles are facing inward towards the pathway and are in direct contact with the cow's hooves and a plurality of water nozzles that are directed towards the pathway. The footbath also includes a plurality of braces that are disposed behind the side walls to provide additional support to said side walls, a plurality of handles disposed on the base path surface to facilitate grasping and transporting the cattle foot bath and a plurality of attachment studs to secure the cattle footbath to a ground surface.

### TECHNICAL FIELD & BACKGROUND

Cattle with manure on their feet often develop foot rot, laminitis, and interdigital warts due to stored moisture. Traditional foot baths simply soak the cow's hoofs and do little if anything to clean a cow's hoof.

The present invention generally relates to a cattle foot bath. More specifically, the invention is a cattle foot bath with a brush and a plurality of water nozzles.

It is an object of the invention to provide a cattle foot bath with a brush and a plurality of water nozzles that effectively eliminates common cattle hoof problems.

It is an object of the invention to provide a cattle foot bath with a brush and a plurality of water nozzles that cleans a cow's hoofs as the cow walks over the cattle foot bath.

It is an object of the invention to provide a cattle foot bath with a brush and a plurality of water nozzles that cleans manure or other debris off of a cow's hoofs as the cow walks over the cattle foot bath.

What is really needed is a cattle foot bath with a brush and a plurality of water nozzles that effectively eliminates common cattle hoof problems, that cleans a cow's hoofs as the cow walks over the cattle foot bath and that cleans manure or other debris off of a cow's hoofs as the cow walks over the cattle foot bath.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overhead perspective view of a cattle foot bath, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

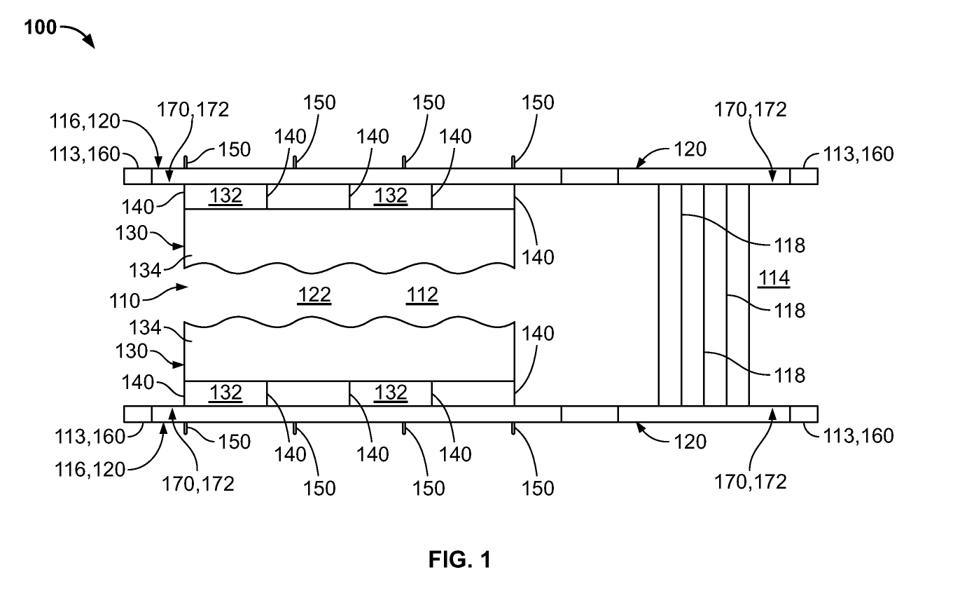

FIG. 1 illustrates an overhead perspective view of a cattle foot bath 100, in accordance with one embodiment of the present invention.

The cattle foot bath 100 includes a base path surface 110, a pair of side walls 120, a pair of brushes 130, a plurality of water nozzles 140, a plurality of braces 150, a plurality of handles 160 and a plurality of attachment studs 170.

The base path surface 110 is a planar sheet of water resistant plastic material that includes a front surface 112 with a front portion 114, four corners 113 and two side portions 116, although the base path surface 110 can be made of other suitable materials as well. The front surface 112 has a plurality of vertical treads 118 disposed on the front portion 114 to prevent a cow or other animal entering the cattle foot bath 100 from slipping or falling. The base path surface 110 is approximately 12 feet long and 18 inches wide although the base path surface 110 can be other suitable dimensions as well. The side walls 120 are adjustably disposed on the side portions 116 of the base path surface 110 and form a pathway 122 in the range of approximately 4 to 10 inches wide for a cow to walk through. The side walls 120 are also approximately 6 inches in height and can be other suitable heights as well. The brushes 130 include a base 132 and a plurality of bristles 134 and are disposed adjacently inward from the side walls 120 where the bristles 134 are facing inward towards the pathway 122. The bristles 134 are in direct contact with the cow's hooves and clean the hooves as the cow walks through the pathway making contact with the bristles 134.

The water nozzles 140 are directed towards the pathway 122 and are incorporated into the base 132 of the brushes 130 and spray water onto the pathway 122 and cow hooves. The water nozzles 140 can be changed to spray a variety of different water volumes and water pressures as needed. The braces 150 are disposed behind the side walls 120 to provide additional support to the side walls 120. The handles 160 are disposed on each corner 113 of the base path surface 110 to facilitate grasping and transporting the cattle foot bath 100. The attachment studs 170 accommodate a plurality of attachment apertures 172 disposed on each corner 113 and are inserted through the attachment apertures 172 and into any apertures disposed on a surface which is typically a ground surface where the cattle foot bath 100 is being secured to.

The cattle foot bath with a brush and a plurality of water nozzles effectively eliminates common cattle hoof problems and cleans a cow's hoofs as the cow walks over the cattle foot bath and that cleans manure or other debris off of a cow's hoofs as the cow walks over the cattle foot bath.

Comprised of an approximate 12 foot long walkway 18 inches wide with approximate 6 inch sidewalls afforded with an approximate 10 foot section of brushes, the cattle foot bath is a superior alternative to current cattle foot baths. The cattle foot bath is relatively easy to use, as cattle walk through the cattle foot bath, the water injecting nozzles incorporated onto the brooms will thoroughly clean the hoofs of the cattle, simulating the experience of walking in a field of grass. The cattle foot bath includes sidewalls that include reinforcement braces and the base that includes 4 bottom studs allowing the user to set the cattle foot bath in a plurality of pilot holes onto a floor or other ground surface. Equipped with carrying handles to facilitate lifting and hanging on a wall when not in use, the cattle foot bath is both convenient and durable. The cattle foot bath features a 12 foot walk equipped with interchangeable brushes and water nozzles to accommodate any softness or volume requirements. The cattle foot bath is designed to be easily washed out and cleaned and allows chemicals or other additives to be added onto the cattle foot bath.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A cattle footbath utilized to clean debris off of a cow with a plurality of hoofs, comprising:
a base path surface with a front surface with a front portion, four corners and two side portions that is a planar sheet of material;
a pair of side walls that are adjustably disposed on said side portions of said base path surface that form a pathway to accommodate said cow to walk through;
a pair of brushes with a base and a plurality of bristles that are disposed adjacently inward from said side walls where said bristles are facing inward towards said pathway and are in direct contact with said cow's hooves and clean said hooves as said cow walks through said pathway;
a plurality of water nozzles that are directed towards said pathway and are incorporated into said base of said brushes and spray water onto said pathway and said cow hooves;
a plurality of braces that are disposed behind said side walls to provide additional support to said side walls;
a plurality of handles disposed on said base path surface to facilitate grasping and transporting said cattle foot bath; and
a plurality of attachment studs to secure said cattle footbath to a ground surface.

2. The footbath according to claim 1, wherein said planar sheet is made of water-resistant material.

3. The footbath according to claim 1, wherein said front surface has a plurality of vertical treads disposed on said front portion to prevent a cow entering said cattle foot bath from slipping or falling.

4. The footbath according to claim 1, wherein said water nozzles are changed to spray a plurality of different water volumes and water pressures.

5. The footbath according to claim 1, wherein said handles are disposed on said corners of said base path surface.

6. The footbath according to claim 1, wherein said attachment studs accommodate a first plurality of attachment apertures disposed on said corner of said base path surface and are inserted through said attachment apertures and into a second plurality of apertures disposed on said ground surface.

7. A plastic cattle footbath utilized to clean debris off of a cow with a plurality of hoofs, comprising:
a water-resistant base path surface with a front surface with a front portion, four corners and two side portions that is a planar sheet of material;
a pair of side walls that are adjustably disposed on said side portions of said base path surface that form a pathway to accommodate said cow to walk through;
a pair of brushes with a base and a plurality of bristles that are disposed adjacently inward from said side walls where said bristles are facing inward towards said pathway and are in direct contact with said cow's hooves and clean said hooves as said cow walks through said pathway;
a plurality of water nozzles that are directed towards said pathway and are incorporated into said base of said brushes and spray water onto said pathway and said cow hooves;
a plurality of braces that are disposed behind said side walls to provide additional support to said side walls;
a plurality of handles disposed on said base path surface to facilitate grasping and transporting said cattle foot bath; and
a plurality of attachment studs to secure said cattle footbath to a ground surface.

8. The footbath according to claim 7, wherein said front surface has a plurality of vertical treads disposed on said front portion to prevent a cow entering said cattle foot bath from slipping or falling.

9. The footbath according to claim 7, wherein said water nozzles are changed to spray a plurality of different water volumes and water pressures.

10. The footbath according to claim 7, wherein said handles are disposed on said corners of said base path surface.

11. The footbath according to claim 7, wherein said attachment studs accommodate a first plurality of attachment apertures disposed on said corner of said base path surface and are inserted through said attachment apertures and into a second plurality of apertures disposed on said ground surface.

12. The footbath according to claim 7, wherein at least one chemical or other additive is added to clean said cattle foot bath.

13. A plastic cattle footbath utilized to clean debris off of a cow's hoofs, comprising:
a water-resistant base path surface with a front surface with a front portion, four corners and two side portions that is a planar sheet of material wherein said front surface has a plurality of vertical treads disposed on said front portion to prevent a cow entering said cattle foot bath from slipping or falling;
a pair of side walls that are adjustably disposed on said side portions of said base path surface that form a pathway to accommodate said cow to walk through;
a pair of brushes with a base and a plurality of bristles that are disposed adjacently inward from said side walls where said bristles are facing inward towards said pathway and are in direct contact with said cow's hooves and clean said hooves as said cow walks through said pathway;
a plurality of water nozzles that are directed towards said pathway and are incorporated into said base of said brushes and spray water onto said pathway and said cow hooves;
a plurality of braces that are disposed behind said side walls to provide additional support to said side walls;
a plurality of handles disposed on said corners of said base path surface to facilitate grasping and transporting said cattle foot bath; and
a plurality of attachment studs to secure said cattle footbath to a ground surface.

14. The footbath according to claim 13, wherein said base path surface is approximately 12 feet long and 18 inches wide.

15. The footbath according to claim 13, wherein said side walls are in the range of approximately 4 to 10 inches wide.

16. The footbath according to claim 13, wherein said side walls are approximately 6 inches in height.

17. The footbath according to claim 13, wherein said brushes form an approximate 10 foot long brushes section.

18. The footbath according to claim 13, wherein said water nozzles are changed to spray a plurality of different water volumes and water pressures.

19. The footbath according to claim 13, wherein said attachment studs accommodate a first plurality of attachment apertures disposed on said corner of said base path surface and are inserted through said attachment apertures and into a second plurality of apertures disposed on said ground surface.

20. The footbath according to claim 13, wherein at least one chemical or other additive is added to clean said cattle foot bath.
